(19) United States
(12) Patent Application Publication
(10) Pub. No.: US 2017/0251699 A1
(43) Pub. Date: Sep. 7, 2017

(54) PRESSED POWDER PET CHEWS AND METHODS OF MANUFACTURE

(71) Applicant: HIMALAYAN CORPORATION, Mukitteo, WA (US)

(72) Inventor: SUMAN K. SHRESTHA, Marysville, WA (US)

(21) Appl. No.: 15/449,521

(22) Filed: Mar. 3, 2017

Related U.S. Application Data
(60) Provisional application No. 62/303,196, filed on Mar. 3, 2016.

(51) Int. Cl. A23K 50/42; A23K 40/20; A23K 10/00

(52) U.S. Cl. CPC A23K 50/42; A23K 10/00; A23K 40/20

(57) ABSTRACT

Pressed powder pet chew products and methods of manufacturing such products are disclosed. Pressed powder pet chew products may comprise “pressed bone” and “knotted bone” pet chew products. Pressed bone pet chew products may comprise a shaped, pressed and hardened powder mixture. The powder mixture may comprise a cheese powder which may optionally be mixed with other powdered substances. The powder mixture may be heated, poured into a mold, pressed, and dried in order to produce the single block pressed powder pet chew products. Knotted bone pet chew products may comprise multiple stacked and knotted layers of hardened powder mixture. The powder mixture may be heated, formed into strips, stacked, knotted, and dried in order to produce the knotted bone pet chew products.

### CROSS-REFERENCE TO RELATED APPLICATION

This is a nonprovisional application which claims priority under 35 U.S.C. §119 of U.S. Provisional Patent Application 62/303,196, entitled “PRESSED POWDER PET CHEWS AND METHODS OF MANUFACTURE”, filed on Mar. 3, 2016.

### BACKGROUND

There are a variety of popular pet chew products available in pet supply stores, such as bones, ropes, rawhides, bully sticks, rubber chew toys, and hardened cheeses. Himalayan Dog Chews, imported from Nepal and distributed in the United States by the Himalayan Corporation, are one example of hardened cheese pet chews generally made of yak or cow milk. There is an ongoing need to increase the variety of pet chew products to meet the needs and preferences available to dog and other pet owners.

### SUMMARY

Pressed powder pet chew products and methods of manufacturing such products are disclosed. Some example pressed powder pet chew products may comprise “pressed bone” pet chew products. Pressed bone pet chew products may comprise a shaped, pressed and hardened single unit made from a powder mixture. Some example pressed powder pet chew products may comprise “knotted bone” pet chew products. Knotted bone pet chew products may comprise multiple folded/knotted layers made from a powder mixture.

In some embodiments, the powder mixture may comprise only a cheese powder. In some embodiments, the powder mixture may comprise a cheese powder which is mixed with one or more other powder or non-powder substances, such as a fruit powder, a vegetable powder, a fruit starch, a vegetable starch, glycerin, sorbitol, preservatives and/or a chicken, fish, duck, rabbit, beef or other animal powder or meal.

An example method of manufacturing “pressed bone” pet chew products may comprise formulating a powder mixture, e.g., by mixing a cheese powder with one or more other substances, in desired amounts. The formulated powder mixture may be heated to make a softened intermediate product. The softened intermediate product may be placed in a mold of any desired dimensions. For example, a bone-shaped mold may be used. The mold may be placed in a press. The softened intermediate product may then be pressed. The resulting pressed powder pet chew product may then be hardened, for examply by drying the pressed powder pet chew product until it reaches a desired moisture and hardness.

An example method of manufacturing “knotted bone” pet chew products may comprise formulating a powder mixture, e.g., by mixing a cheese powder with one or more other substances, in desired amounts. Thin, malleable strips of the formulated powder mixture may be formed using several optional approaches. In some approaches, the formulated powder mixture may be heated and extruded in an extruding device to form the strips. In some other approaches, the formulated powder mixture may be heated to make a softened intermediate product; the softened intermediate product may be placed in a mold and pressed in a press to form a pressed block; amd the pressed block may be cut to produce the strips.

Regardless of how the strips are formed, the resulting strips may be folded/knotted into knotted bone pet chew products. For example, multiple strips may be stacked together, and knotted at each end in order to form a bone-shaped knotted bone pet chew product. The knotted bone pet chew product may then be hardened, for examply by drying the knotted bone pet chew product until it reaches a desired moisture and hardness.

Additional aspects of this disclosure are described in further detail below.

### BRIEF DESCRIPTION OF THE DRAWINGS

Various features and attendant advantages of the disclosed technologies will become fully appreciated when considered in conjunction with the accompanying drawings, in which like reference characters designate the same or similar parts throughout the several views, and wherein:

FIG. 1 illustrates an example “pressed bone” pet chew product.

FIG. 2 illustrates an example method of manufacturing a pressed bone pet chew product.

FIG. 3 illustrates an example “knotted bone” pet chew product.

FIG. 4 illustrates an example method of manufacturing a knotted bone pet chew product.

### DETAILED DESCRIPTION

Prior to explaining embodiments of the invention in detail, it is to be understood that this disclosure is not limited to the details of construction or arrangements of the components and method steps set forth in the following description or illustrated in the drawings. Embodiments of this disclosure are capable of other embodiments and of being practiced and carried out in various ways. Also, it is to be understood that the phraseology and terminology employed herein are for the purpose of the description and should not be regarded as limiting.

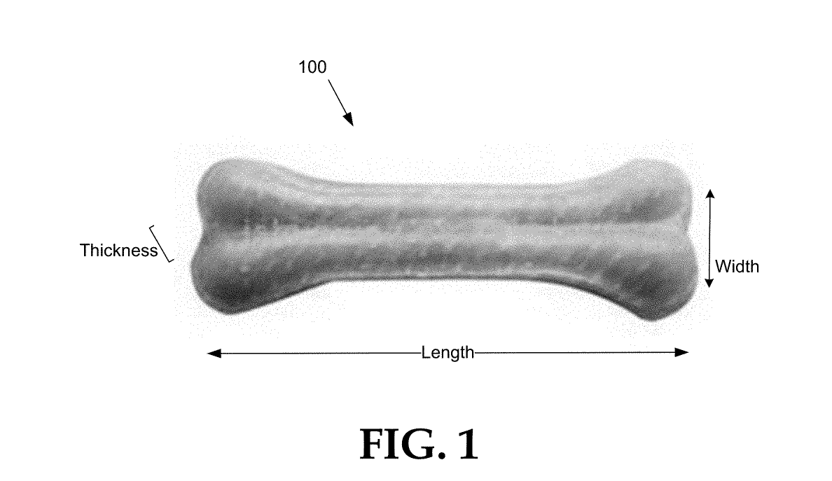

FIG. 1 illustrates an example “pressed bone” pet chew product 100. The pressed bone pet chew product 100 may have a length in the range of about 1.5 inches to 12 inches, a width in the range of about 0.5 inches to 3 inches, and a thickness of about 0.5 inches to 3 inches. The pressed bone pet chew product 100 may be shaped, e.g., in a bone shape comprising an elongated middle section and bulbous end sections at either end of the elongated middle section, as shown. In some embodiments, the pressed bone pet chew product 100 may have a center depression extending the length of the pressed bone pet chew product 100, as shown. The pressed bone pet chew product 100 may have a moisture content of about 5%-15%, or in some embodiments, a moisture content of about 8%-12%.

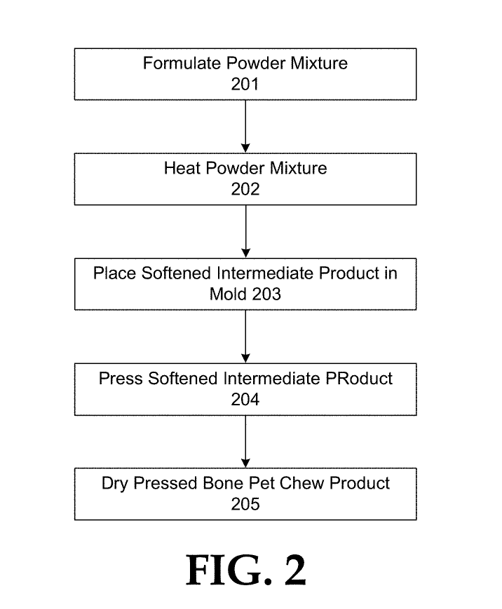

FIG. 2 illustrates an example method of manufacturing a pressed bone pet chew product. Methods according to FIG. 2 may be used, for example, to manufacture the pressed bone pet chew product 100 illustrated in FIG. 1. FIG. 2 includes a “Formulate Powder Mixture” block 201, a “Heat Powder Mixture” block 202, a “Place Softened Intermediate Product in Mold” block 203, a “Press Softened Intermediate Product” block 204, and a “Dry Pressed Bone Pet Chew Product” block 205.

At “Formulate Powder Mixture” block 201, any of a variety of powder and/or non-powder substances may be mixed in desired ratios to formulate a desired powder mixture. In some embodiments, the powder mixture may comprise only a cheese powder. The cheese powder may be produced, for example, by grinding one or more types of hardened cheese into a powder. The hardened cheeses may include, e.g., Himalayan hard cheese and/or American hard cheese. Any desired ratio of different hardened cheeses may be used, e.g., in some embodiments, a substantially 50/50 blend of Himalayan and American hard cheeses may be used.

In some embodiments, the powder mixture may comprise a cheese powder which is mixed in desired ratios with one or more other powder or non-powder substances. For example, in some embodiments, the powder mixture may comprise a “substantial” amount of cheese powder, defined herein as 51% or more cheese powder, mixed with one or more other powder or non-powder substances. In some embodiments, the powder mixture may comprise about 51%-55% cheese powder, mixed with one or more other powder or non-powder substances. In some embodiments, the powder mixture may comprise about 10%-30% cheese powder, mixed with one or more other powder or non-powder substances. Example powder substances which may be mixed with the cheese powder, in desired ratios, include fruit powder, vegetable powder, fruit starch, vegetable starch, and chicken, fish, duck, rabbit, beef or other animal powder or meal. Example powder substances which may be mixed with the cheese powder, in desired ratios, include glycerin, sorbitol, and preservatives. In some embodiments, the powder mixture may comprise about about 70%-90% vegetable starch, mixed with cheese powder and/or one or more other powder or non-powder substances. In some embodiments, the powder mixture may be mixed at substantially room temperature. Block 201 may be followed by block 202.

At “Heat Powder Mixture” block 202, the formulated powder mixture may be heated to make a softened intermediate product. For example, the formulated powder mixture may be heated in hot water to a temperature of about 145°-195° Farenheit. When heated, formulated powder mixtures described herein will transform into a softened intermediate product. It will be appreciated that other heating techniqes may also be used, such as steaming, heating in saltwater, oil or other liquids, or heating in an oven or under a heat lamp, etc. In some embodiments, block 201 and 202 may be combined, by adding the various elements of the powder mixture, separately and in desired ratios, directly into hot water. Block 202 may be followed by block 203.

At “Place Softened Intermediate Product in Mold” block 203, the softened intermediate product may be placed in a mold of any desired shape and dimensions, e.g., a mold having a shape and dimensions of the pressed bone pet chew product 100 illustrated in FIG. 1. The softened intermediate product may be scooped, strained, filtered, or otherwise removed from the hot water used to heat it at block 202, and the softened intermediate product may be placed directly in the mold. Block 203 may be followed by block 204.

At “Press Softened Intermediate Product” block 204, the mold containing the softened intermediate product may be placed in a press, e.g. a hydraulic press machine. The mold may be pressed at a pressure within the range of about 5 tons to about 60 tons, for about 30-90 seconds. The mold may be removed from the press, and the resulting pressed bone pet chew product may be removed from the mold. Block 204 may be followed by block 205.

At “Dry Pressed Bone Pet Chew Product” block 205, the pressed bone pet chew product may be placed in the open air to dry for a period of about 1 day up to 5 weeks or more, or until a desired moisture and hardness level is achieved. In some embodiments, the pressed bone pet chew product 100 may be dried to a moisture content of about 5%-15%, or in some embodiments, a moisture content of about 8%-12%.

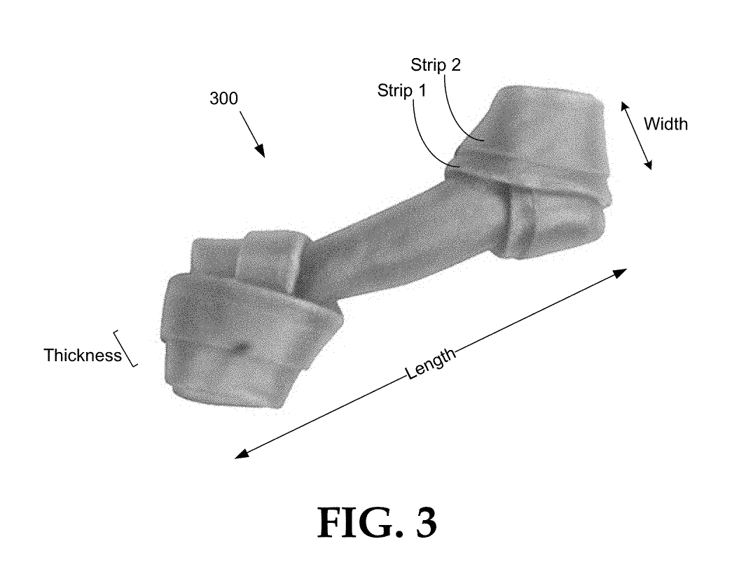

FIG. 3 illustrates an example “knotted bone” pet chew product 300. The knotted bone pet chew product 300 may have a length in the range of about 1.5 inches to 12 inches, a width in the range of about 0.5 inches to 3 inches, and a thickness of about 0.5 inches to 3 inches. The knotted bone pet chew product 300 may be formed from multiple pressed powder strips, including, e.g. strip 1 and strip 2. Prior to folding/knotting, each strip may have a length in the range of about 3 inches to about 18 inches. Each strip may have a width in the range of about 1 inch to about 8 inches. Each strip may have a thickness in the range of about 1 millimeter to about 5 millimeters.

The strips may be stacked and then folded or knotted together, e.g., the strips may be knotted at each end to form a knotted bone 300 such as illustrated in FIG. 3. It will be appreciated that a variety of other folding or knotting techniques may be used to produce different shapes having different relative strengths to withstand the stress of pet chewing. The illustrated knotted bone pet chew product 300 has a bone shape comprising an elongated middle section and bulbous end sections at either end of the elongated middle section, as shown. The knotted bone pet chew product 300 may have a moisture content of about 5%-15%, or in some embodiments, a moisture content of about 8%-12%.

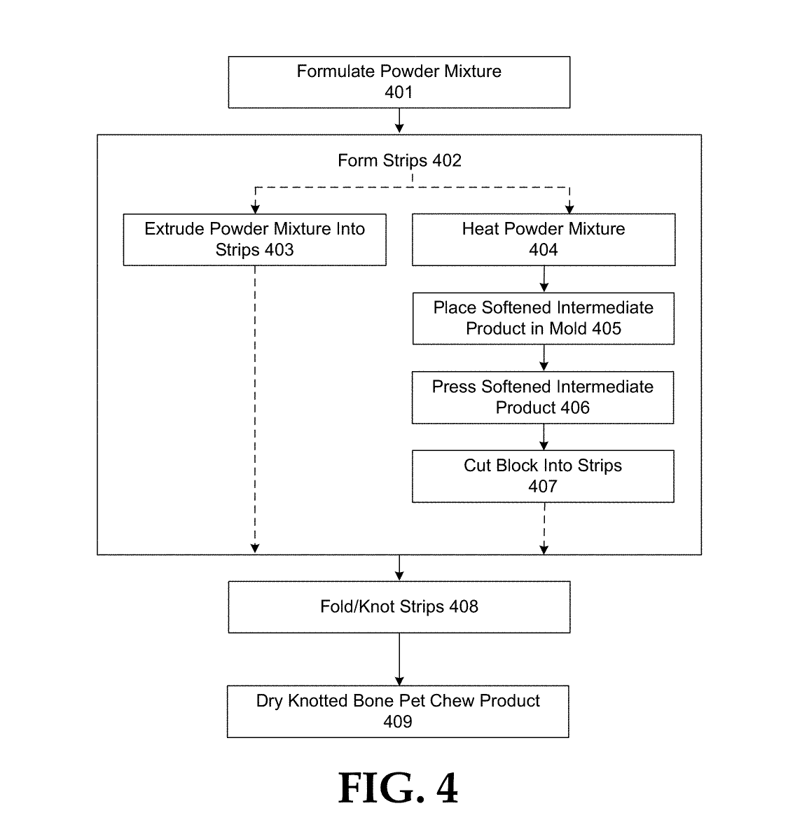

FIG. 4 illustrates an example method of manufacturing a knotted bone pet chew product. Methods according to FIG. 4 may be used, for example, to manufacture the knotted bone pet chew product 300 illustrated in FIG. 3. FIG. 4 includes a “Formulate Powder Mixture” block 401, a “Form Strips” block 402, an “Extrude Powder Mixture into Strips” block 403, a “Heat Powder Mixture” block 404, a “Place Softened Intermediate Product in Mold” block 405, a “Press Softened Intermediate Product” block 406, a “Cut Block into Strips” block 407, a “Fold/Knot Strips” block 408, and a “Dry Knotted Bone Pet Chew Product” block 409.

At “Formulate Powder Mixture” block 401, any of a variety of powder and/or non-powder substances may be mixed in desired ratios to formulate a desired powder mixture, as described herein in connection with FIG. 2. Block 401 may be followed by block 402.

At “Form Strips” block 402, thin, malleable strips of the formulated powder mixture may be formed using any of several optional approaches. Block 403 illustrates an example extrusion approach, and blocks 404-407 illustrated an example press and cut approach.

At “Extrude Powder Mixture into Strips” block 403, the formulated powder mixture may be simultaneously heated and extruded in an extruding device to form the strips. When the formulated powder mixture is mixed at substantially room temperature, it becomes a dry crumbly dough. This dough may be placed into the extruding device which may be set to heat it to about 145°-195° Farenheit. The extruding device may also be adapted to produce any desired shape of extruded output strips. In some embodiments, the extruding device may be configured to output substantially rectangular extruded strips, or substantially “L” shaped extruded strips, or other shapes as convenient. Block 403 may be followed by block 408.

At “Heat Powder Mixture” block 404, the formulated powder mixture may be heated to make a softened intermediate product, as described herein in connection with FIG. 2. Block 404 may be followed by block 405.

At “Place Softened Intermediate Product in Mold” block 405, the softened intermediate product may be placed in a mold of any desired shape and dimension as described herein in connection with FIG. 2. For example, in order to ultimately produce rectangular strips, a substantially rectangular block shaped mold may be used. Block 405 may be followed by block 406.

At “Press Softened Intermediate Product” block 406, the mold containing the softened intermediate product may be pressed, as described herein in connection with FIG. 2. Block 406 may be followed by block 407.

At “Cut Block into Strips” block 407, the pressed powder block, or other shape removed from the mold after pressing, may be cut into strips of any desired shapes, thicknesses, or dimensions. For example, in some embodiments, strips having the dimensions described in connection with FIG. 3 may be cut. The strips may be cut by knife, saw, or other cutting tools. Block 407 may be followed by block 408.

At “Fold/Knot Strips” block 408, the strips produced at block 402 may be stacked and folded/knotted together. For example, multiple strips, e.g., 2-4 strips, may be stacked one on top of the other to produce a multi-layered stack. In some embodiments, the stacked strips may be folded/knotted at each end in order to form a bone-shaped knotted bone pet chew product such as described in connection with FIG. 3. As can be understood from FIG. 3, the knots used to knot the illustrated product 300 may for example include an “overhand” type knot in which one forms a loop, passes the strip ends end through the loop, and tightens. Such knots may be formed by hand in some embodiments. The ends of the strips may optionally be trimmed to produce the clean knotted bone shape illustrated in FIG. 3. Block 408 may be followed by block 409.

At “Dry Knotted Bone Pet Chew Product” block 408, the knotted bone pet chew product may be placed in the open air to dry for a period of about 1 day up to 5 weeks or more, or until a desired moisture and hardness level is achieved, as described herein in connection with FIG. 2.

While various embodiments have been disclosed herein, other aspects and embodiments will be apparent to those skilled in art.

1. A pressed powder pet chew product comprising a pressed bone pet chew product, the pressed bone pet chew product comprising:
a powder mixture comprising cheese powder;
wherein the powder mixture is heated and pressed in a mold to produce a single unit pressed bone pet chew product; and
the pressed bone pet chew product having a moisture content of about 5%-15%.

2. The pressed powder pet chew product of claim 1, wherein the powder mixture further comprises one or more of a fruit powder, a vegetable powder, a fruit starch, a vegetable starch, glycerin, sorbitol, preservatives, and/or a chicken, fish, duck, rabbit, beef or other animal powder or meal.

3. The pressed powder pet chew product of claim 1, wherein the pressed powder pet chew product comprises 51% or more cheese powder.

4. A method of manufacturing a pressed powder pet chew product, the pressed powder pet chew product comprising a pressed bone pet chew product, wherein the method comprises:
formulating a powder mixture comprising cheese powder;
heating the powder mixture in order to produce a softened intermediate product;
placing the softened intermediate product in a mold;
pressing the mold in a press to form the pressed bone pet chew product; and
drying the pressed bone pet chew product until it reaches a desired moisture content.

5. A pressed powder pet chew product comprising a knotted bone pet chew product, the knotted bone pet chew product comprising:
multiple stacked, knotted, and dried pressed powder strips, each pressed powder strip being formed from a powder mixture comprising cheese powder, wherein the powder mixture is either extruded to form the pressed powder strips, or wherein the powder mixture is heated, pressed in a mold, and cut to form the pressed powder strips; and
wherein the knotted bone pet chew product has a moisture content of about 5%-15%.

6. The pressed powder pet chew product of claim 5, wherein the powder mixture further comprises one or more of a fruit powder, a vegetable powder, a fruit starch, a vegetable starch, glycerin, sorbitol, preservatives, and/or a chicken, fish, duck, rabbit, beef or other animal powder or meal.

7. The pressed powder pet chew product of claim 1, wherein the pressed powder pet chew product comprises 51% or more cheese powder.

8. A method of manufacturing a pressed powder pet chew product, the pressed powder pet chew product comprising a knotted bone pet chew product, wherein the method comprises:
formulating a powder mixture comprising cheese powder;
forming multiple thin, malleable strips from the powder mixture;
stacking the strips;
tying the stacked strips in at least one knot in order to form a knotted bone pet chew product; and
drying the knotted bone pet chew product until it reaches a desired moisture content.

8. The method of manufacturing a pressed powder pet chew product of claim 8, wherein forming multiple thin, malleable strips from the powder mixture comprises extruding the powder mixture into the strips.

9. The method of manufacturing a pressed powder pet chew product of claim 8, wherein forming multiple thin, malleable strips from the powder mixture comprises heating the powder mixture, pressing the powder mixture in a mold, and cutting a pressed powder block removed from the mold into the strips.
